(19) United States
(12) Patent Application Publication
(10) Pub. No.: US 2020/0247705 A1
(43) Pub. Date: Aug. 6, 2020

(54) METHOD AND DEVICE FOR BENDING PANES

(71) Applicant: SAINT-GOBAIN GLASS FRANCE, COURBEVOIE (FR)

(72) Inventors: Arthur PALMANTIER, Aachen (DE); Jean Jacques BRIS, Bey (FR); Jack PENNERS, Herzogenrath (DE); Achim ZEICHNER, Herzogenrath (DE); Werner KAHLEN, Herzogenrath (DE)

(21) Appl. No.: 16/635,054

(22) PCT Filed: Jun. 22, 2018
(86) PCT No.: PCT/EP2018/066744

§ 371 Date: Jan. 29, 2020

(30) Foreign Application Priority Data
Jul. 31, 2017 (EP) 17183928.5

(51) Int. Cl. C03B 23/03; C03B 23/035; C03B 35/20

(52) U.S. Cl. CPC C03B 23/0307; C03B 27/00; C03B 35/207; C03B 23/0357

(57) ABSTRACT

A method for bending panes, includes providing a pane heated to bending temperature, securing the pane against a contact surface of the first bending mould, positioning a press frame for the pane in a first press frame position associated with the first bending mould, transporting the pane on the press frame to a second press frame position associated with the second bending mould, securing the pane against a contact surface of the second bending mould, wherein the press frame is attached to a carrier introduced into the bending zone by a delivery module, and wherein the press frame is moved laterally relative to the first and second bending mould by moving the carrier between the first press frame position and the second press frame position.

The invention relates to a method and a device for bending panes and use thereof. Various bending methods, many of which have already found their way into the patent literature, are used in the industrial series production of glass panes.

For example, WO 2012/080072 describes a method with incremental bending of glass panes in the edge region and the inner region. Here, the glass pane is first moved on a pre-bending ring into a furnace, wherein the pane edge is pre-bent, followed by further bending of the pane edge by a first suction device, placement and bending of the glass pane in the surface on a final bending ring and finish bending to the desired final geometry by means of a second suction device. By means of the incremental bending of the glass panes, optical defects in complex plane shapes can be reduced.

In WO 2004/087590 and WO 2006072721, in each case, a method is described in which the glass pane is first pre-bent by gravity on a bending frame, followed by press bending using an upper or lower bending mould.

EP 255422 and U.S. Pat. No. 5,906,668 describe in each case the bending of a glass pane by suction against an upper bending mould.

In EP 1550639 A1, US 2009/084138 A1, and EP 2233444 A1, in each case, a device can be seen wherein a press frame on a carriage that is displaceably mounted on a stationary carrier is transportable between bending stations.

Generally, there is a need for relatively compact systems for bending glass panes, wherein the glass panes should be producible with relatively short cycle times and low production costs. In addition, it should be possible to meet high quality requirements.

Consequently, the object of the present invention consists in making available an improved method compared to the previously known methods as well as a corresponding device for bending glass panes. These and other objects are accomplished according to the proposal of the invention by a device and a method for bending glass panes with the features of the coordinate claims. Advantageous embodiments of the invention are apparent from the dependent claims.

In the context of the present invention, the term “pre-bending” refers to an incomplete bending of the pane relative to a defined or definable final bending (final geometry or final shape) of the pane. The pre-bending can, for example, account for 10 to 80% of the final bending. When used as “edge pre-bending”, the term refers to the incomplete bending of the pane in a peripheral edge region of the pane adjacent a pane edge, typically an edge region surrounding the pane in a strip-like manner. For example, the strip width is in the range from 3 to 150 mm. The pane edge is formed by a (cut) surface that is typically arranged perpendicular to the two primary surfaces of the pane opposite one another. When used as “surface pre-bending”, the term refers to the incomplete bending of the pane in a central or inner region of the pane, which is surrounded by the edge region and is directly adjacent the edge region. In contrast, the term “final bending” refers to the complete bending of the pane. When used as “edge final bending”, the term refers to the complete bending in the edge region of the pane; when used as “surface final bending”, to the complete bending in the inner region of the pane.

The term “pane” refers generally to a glass pane, in particular a thermally tempered soda lime glass.

The term “laterally” or “laterally displaceable” refers to a movement with at least one horizontal moving component, as a result of which a structural component can be arranged laterally relative to another structural component.

The device according to the invention for bending panes comprises multiple zones that are structurally and functionally distinguishable from one another. According to the invention, a bending zone for bending heated panes, which is advantageously equipped with a heating device for heating the panes, is an essential element. In particular, the bending zone can, for this purpose, be brought to a temperature that enables plastic deformation of panes and is typically in the range from 600° C. to 750° C.

The bending zone is preferably implemented as a heatable chamber closed or closable to the external environment, referred to in the following as “bending chamber”, The bending chamber has a bending chamber hollow space that is completely delimited by a preferably insulated wall. The bending chamber hollow space has at least one opening into the bending chamber hollow space, which is preferably closable by a bending chamber door. The bending zone comprises at least two bending moulds, i.e., a first bending mould and a second bending mould. that are preferably arranged in the bending chamber hollow space of a bending zone implemented as a bending chamber.

In an advantageous embodiment of the invention, the first bending mould and the second bending mould have in each case a contact surface for contacting a pane. The contact surface of the first bending mould and of the second bending mould has in each case an outer surface section and an inner surface section or is composed of the outer and inner surface section. The outer surface section of the first bending mould and of the second bending mould is in each case suitably designed for edge final bending in an edge region of the pane. Preferably, the inner surface section of the first bending mould and of the second bending mould is in each case suitably designed for surface pre-bending in a central or inner region of the pane surrounded by the edge region. Alternatively, the inner surface section of the second bending mould can be suitably designed for surface final bending.

As used here and in the following, the phrase “suitably designed” in connection with the outer surface section of the contact surface means that the outer surface section is shaped such that an edge final bending of the pane can be produced. However, the pane does not mandatorily have to be subjected to edge final bending, instead, it is possible for only edge pre-bending to be done. The edge final bending is, in that case, not produced until later in the process. The outer surface section does not, for this purpose, necessarily have to have a shape that is complementary to the shape of a pane that is finally bent at the edge. In connection with the inner surface section of the contact surface “suitably designed” means that the inner surface section is shaped such that surface pre-bending of the pane can be produced, whereby surface pre-bending does not mandatorily have to be done. If the inner surface section of the second bending mould is, alternatively, suitably designed for surface final bending, this means that a surface final bending can be produced, but does not necessarily have to be produced. The surface final bending can even be produced only later in the process.

In this embodiment of the invention, the press frame (e.g., press ring) described below in connection with the module has a press surface (contact surface) for pressing a pane, which is also designed complementary to an outer surface section of the first bending mould or the second bending mould suitable for edge final bending. The press surface is, for example, designed in the form of a strip, for example, with a strip width in the range from 3 to 150 mm. The press surface is oriented upward for contact with a pane. In addition, the press frame is suitably designed for pre-bending the surface by means of gravity in the inner region of the pane, wherein a sagging of the inner region of the pane downward by means of gravity is possible. The press frame can, for this purpose, be open, in other words, be provided with a central opening, or be full-surface, so long as sagging of the inner region of the pane is enabled. In terms of simpler processing of panes, an open design is preferred. It is understood that a greater width of a strip-shaped press surface is advantageous in terms of avoiding unwanted marks (changes in the flat surfaces of the pane), wherein by pressing the pane on the press frame in the edge region, the creation of marks can be counteracted. The press surface of the press frame has a defined geometry, wherein the press frame is sufficiently rigid for this purpose. The press frame is, for example, formed as a cast part, with the press surface formed, for example, by milling. In gravity bending, the pane is pre-bent by its own weight. As a result of the prior pressing of the pane edge against the press surface of the press frame, the surface pre-bending of the pane can be reduced. In addition, it is advantageously possible to use a stop for fixing the pane during transport on the press frame.

Here, the first bending mould and the press frame are vertically displaceable relative to one another such that the pane can be pressed in the edge region between the outer surface section of the first bending mould and the press surface of the press frame. The pane is thus pre-bent or finally bent in the edge region. The first bending mould is advantageously coupled with a movement mechanism by means of which the first bending mould can be delivered to the press frame.

Similarly, the second bending mould and the press frame are vertically displaceable relative to one another such that the pane can be pressed in the edge region between the outer surface section of the second bending mould and the press surface of the press frame. The pane is thus pre-bent or finally bent in the edge region. The second bending mould is advantageously coupled with a movement mechanism by means of which the second bending mould can be delivered to the press frame.

Due to the bending of a pane in the edge region and the inner region carried out in multiple stages, the bending time on the second bending mould can be significantly reduced in order to shorten the cycle times. In addition, due to the particularly precise positioning of the pane by means of pressing on the press frame, complexly shaped panes with particularly high quality can be produced.

Preferably, the first bending mould and the second bending mould have in each case a means for securing a pane against the respective contact surface. The means for securing a pane against the contact surface advantageously comprises a pneumatic suction device for sucking a gaseous fluid, in particular air, by means of which the pane can be pulled by negative pressure against the respective contact surface. The contact surface can be provided, for this purpose, for example, with at least one suction hole, advantageously with a plurality of suction holes uniformly distributed, for example, over the contact surface, to which a negative pressure can be applied to the contact surface in each case for a suction effect. The suction device can, alternatively or additionally, have an apron surrounding the contact surface, by means of which a negative pressure can be produced on the contact surface. The suction device generates a typically upward directed flow of a gaseous fluid, in particular air, which suffices to firmly hold the pane against the contact surface. This enables, in particular, placing a frame for receiving the pane secured against the contact surface below the pane.

Alternatively or additionally, the means for securing a pane against the contact surface advantageously comprises a pneumatic blowing device for producing a gaseous flow of fluid, in particular a flow of air, which is designed such that a pane is blown on from below by the gaseous flow of fluid, raised thereby, and can be pressed against the contact surface of the first or second bending mould. The blowing device can, in particular, be designed such that the pane secured against the contact surface can be pre-bent in the edge region and/or in the inner region by the pressure exerted by the gaseous flow of air, advantageously at least in the edge region.

As used here and in the following, the term “securing” refers to a fixing of a pane against the contact surface, wherein the pane can be pressed against the contact surface and/or sucked against the contact surface. The securing of a pane against the contact surface is not mandatorily associated with a bending operation. The contact surfaces of the first and second bending mould are in each case oriented downward for contact with a pane.

The device according to the invention further comprises a module, referred to in the following as “delivery module”, which forms a structural unit and is preferably, but not mandatorily, movable relative to the bending zone. The delivery module is preferably spatially separable from the bending zone. The delivery module preferably has an actively or passively drivable movement mechanism for moving the delivery module relative to the bending zone, for example, a roller transport mechanism or an air cushion transport mechanism. Preferably, the delivery module is implemented in the form of a delivery chamber that has a delivery chamber hollow space that is completely delimited by a preferably insulated wall. The delivery chamber hollow space is separated from the external environment by the wall. Preferably, the delivery chamber hollow space is closed or closable and has at least one opening into the delivery chamber hollow space, which is preferably closable by a delivery chamber door. In particular, the delivery chamber hollow space can be spatially separated from the bending zone (bending chamber hollow space) by closing the opening such that there is no spatial connection between the delivery chamber hollow space and the bending zone. Rather, the delivery chamber hollow space and the bending zone (bending chamber hollow space) can be spatially connected to one another or separated from one another by a wall that is provided with a closable opening.

The delivery module has a movable carrier with a press frame preferably fixedly (immovably) mounted on the carrier for pressing and transporting a pane. Preferably, the carrier with the press frame is arranged in the delivery chamber hollow space of a delivery module implemented as a delivery chamber or can be arranged (completely) in the delivery chamber hollow space. The carrier is movable relative to the two bending moulds. The carrier can, in particular, be moved into a position in which it is completely accommodated in the delivery chamber hollow space (and also not partially arranged in the bending zone). In contrast to the prior art mentioned in the introduction, the press frame is not mounted on a carriage movable on a carrier, but, instead, the press frame can be moved by moving just the carrier itself. The term “press frame” is understood to mean that the press frame can be used for pressing the pane, wherein pressing by means of the press frame is advantageous but not mandatory. In particular, the press frame can serve as a transport frame exclusively for transporting the pane between the bending moulds (without pressing).

The delivery module is delivered or preferably deliverable to the bending zone such that the carrier with a press frame can be introduced into the bending zone (from a position outside the bending zone). Preferably, a delivery module implemented in the form of a delivery chamber is delivered or preferably deliverable to a bending zone implemented in the form of a bending chamber, wherein the delivery chamber hollow space is connectable to the bending chamber hollow space. For this purpose, the delivery chamber hollow space has at least one opening that can be brought into position opposite a second opening of the bending chamber hollow space of the bending chamber such that a preferably aligned connection of the delivery chamber hollow space and the bending chamber hollow space can be produced. Preferably, the first opening of the delivery chamber hollow space and/or the second opening of the bending chamber hollow space are in each case provided with a door by means of which the associated opening can be closed. What is essential is the connectability of the delivery chamber hollow space and the bending chamber hollow space, in particular by opening at least one door between the delivery chamber hollow space and the bending chamber hollow space.

According to the invention, the delivery module is delivered or deliverable to the bending zone such that the press frame is movable laterally relative to the first and the second bending mould on the carrier by moving the carrier (introduced from outside the bending zone into the bending zone) between a first press frame position associated with the first bending mould and a second press frame position associated with the second bending mould. Preferably, the first press frame position is situated vertically (e.g., directly) below the first bending mould, and the second press frame position is situated vertically (e.g., directly) below the second bending mould. Advantageously, the press frame is reciprocally and translationally (i.e., 1-dimensionally) movable in a horizontal plane. In addition, the carrier with a press frame can be moved back (completely) into the delivery module, wherein it is preferable for the carrier with a press frame to be able to be completely accommodated in the delivery chamber hollow space of a delivery module implemented in the form of a delivery chamber.

In the device according to the invention, a movement of the press frame within the bending zone (e.g., bending chamber) is done by a movement of the carrier introduced from outside the bending zone, which, in a particularly advantageous manner, enables very accurate positioning of the press frame. The carrier is coupled, for this movement, to a movement mechanism. In fact, for compliance with very high quality requirements for the panes produced, very accurate positioning of the panes relative to the bending moulds is necessary, which typically requires accuracy of less than 1 mm, typically at least approx. 0.5 mm. In order to avoid errors due to thermal expansion in the hot bending zone, a movement mechanism for the carrier can advantageously be arranged in the delivery module in a cool region outside the hot bending zone. In addition, this enables particularly fast positioning of the carrier, which is another significant advantage of the invention since cycle times can thus be reduced.

The carrier for the press frame is coupled to a carrier movement mechanism arranged on the delivery module, as a result of which a section of the carrier supporting the press frame can be introduced from the delivery module into the bending zone and moved back to the delivery module. In particular, the press frame can be brought by moving the carrier into a position in which it is completely accommodated in the delivery chamber hollow space. The carrier can be moved by the carrier movement mechanism such that the press frame can be moved laterally in a reciprocal manner within the bending zone between the first press frame position and second press frame position.

In an advantageous embodiment of the device according to the invention, at least one support device for supporting the press frame and/or the carrier is provided at the first press frame position and/or the second press frame position. In particular, a separate support device can be arranged in each case at the first press frame position and the second press frame position, for example, a servomotor or a hydraulic or pneumatic support device, by means of which the press frame and/or carrier is supported downward. This enables very precise positioning of the press frame, wherein position changes of the press frame, caused in particular by contact with the bending mould arranged above, can be advantageously avoided.

In another advantageous embodiment of the device according to the invention, at least one tool connectable to the first and/or the second bending mould is transportable on the carrier, for example, by means of a tool support mounted on the carrier. The tool is movable laterally relative to the first and second bending mould by moving the carrier between the delivery module and a first tool position associated with the first bending mould and/or a second tool position associated with the second bending mould. Preferably, the first tool position is situated vertically (e.g., directly) below the first bending mould and the second tool position is situated vertically (e.g., directly) below the second bending mould. Preferably, but not mandatorily, the first press frame position is identical to the first tool position and the second press frame position is identical to the second tool position. The carrier movement mechanism is implemented such that the at least one tool on the carrier can be moved by moving the carrier from the delivery module into the bending zone and from the bending zone to the delivery module. In particular, the carrier can be moved by the carrier movement mechanism such that the at least one tool can be moved laterally in a reciprocal manner into the first tool position or into the second tool position. This embodiment of the invention enables a particularly simple and fast equipping of a bending mould with a tool, in particular a tool change, wherein the at least one tool can be transported on the carrier by moving the carrier from the delivery module to the first or second tool position, in order to equip the first bending mould or bending mould. On the other hand, the tool can be easily removed from the bending zone by placement on the carrier.

Advantageously, a first tool connectable to the first bending mould and a second tool connectable to the second tool can be transported simultaneously on the carrier, wherein, by moving the carrier, the first tool is movable laterally relative to the first and second bending mould between the bending chamber and the first tool position and the second tool is movable laterally between the bending chamber and the second tool position. For this purpose, it is advantageous for the two tools to be positionable with a distance between them on the carrier that corresponds to the distance between the first and the second tool position. Thus, a tool change on both bending moulds can be done in a particularly simple and fast manner.

Particularly advantageously, the at least one tool is arranged in a heatable delivery chamber hollow space of a delivery module implemented as a delivery chamber prior to the equipping of a bending mould. In this manner, the processing of panes in the bending zone can be very quickly continued at the time of a tool change without a time-consuming heating of the tool being required. This is true in particular when changing both tools of the bending moulds. For this purpose, the delivery chamber is provided with a heatable delivery chamber hollow space, in which the at least one tool can be heated.

In the case of a heatable delivery chamber hollow space, it is particularly advantageous for the carrier movement mechanism to be arranged at least partially outside the heatable (hot) delivery chamber hollow space. This makes it possible to advantageously avoid undesirable heating of components of the carrier movement mechanism and thermally induced length changes associated therewith. This contributes significantly to positioning the carrier and, in particular, the press frame attached thereon with particularly high accuracy and high speed such that panes with particularly high quality requirements can be produced.

In addition to particularly accurate positioning of the press frame, the movable delivery module enables simple and fast equipping of the bending moulds of the bending zone with preferably heated tools. For example, a plurality of movable delivery modules provided with mutually different tools can be provided in order to be able to equip the bending zone, as needed, with different tools. Likewise, maintenance or replacement of tools of the bending moulds is easily possible. Here, only one delivery module is delivered in each case to the bending zone.

The delivery module, preferably the delivery chamber, is a self-contained structural unit that enables equipping the delivery module with a tool (tools) and/or press frames as well as replacement of a tool (tools) independently of the bending zone. In particular, the capability of moving the carrier outside enables simple and fast equipping of the delivery module.

When the delivery module, preferably the delivery chamber, is movable, the delivery module can be delivered to the bending zone, preferably the bending chamber, and moved away again. This provides, in particular, free access to the bending zone to perform maintenance or adaptations for a specific bending operation.

Advantageously, the device according to the invention further has a preheating zone with a heating device for heating the panes to a bending temperature as well as a transport mechanism, in particular of the roller bed type, for transporting panes from the preheating zone to the bending zone, in particular to a removal position (e.g., directly) below the first bending mould. The roller bed is advantageously implemented such that individual panes can be transported one after another into the removal position. The removal position can, in particular, correspond to an end section of the roller bed.

Advantageously, the device according to the invention further has a thermal tempering zone with a cooling device for the thermal tempering of a pane, wherein a tempering frame (e.g., a tempering ring) is reciprocally movable laterally relative to the second bending mould (in other words, with at least one horizontal moving component) for transporting a pane from a first tempering frame position associated with the second bending mould, which can, in particular, be identical to the second press frame position, to a second tempering frame position for tempering a pane in the tempering zone. Advantageously, the tempering frame is reciprocally and translationally (one-dimensionally) movable in the horizontal plane. By means of thermal prestressing (tempering), a temperature difference between a surface zone and a core zone of the pane is systematically produced in order to increase the breaking strength of the pane. The tempering of the pane is advantageously produced by means of a device for blowing on the pane with a gaseous fluid, preferably air. Preferably, the two surfaces of a pane are simultaneously subjected to a cooling flow of air.

With lateral displacement of the press frame and the tempering frame, a single pane is transported in each case, enabling processing of two panes simultaneously on the two bending moulds, while a third pane is situated in the tempering zone. As a result of the preferably reciprocal translational movement of the press frame and/or the tempering frame, the individual panes can be transported efficiently and quickly between the various tools. As a result of a bending of a pane in the edge region and the inner region carried out in multiple stages, the bending time on the second bending mould can be significantly reduced in order to shorten the cycle times. In addition, as a result, panes with complex geometry can also be made with high quality.

Advantageously, the tempering frame has, for transporting a pane from the bending zone to the tempering zone, a frame surface suitably designed for the edge final bending in the edge region of the pane. Moreover, it is advantageous for the tempering frame to be suitably designed for surface final bending by means of gravity in the inner region of the pane. During transport of a pane on the tempering frame, edge final bending and surface final bending can be done by gravity.

According to an embodiment of the invention, the preheating zone is implemented in the form of a preheating chamber that has a preheating chamber hollow space that is completely delimited by a preferably insulated wall. The preheating chamber hollow space is separated from the external environment by the wall. For example, the preheating chamber hollow space is closed or closable and has at least one opening into the preheating chamber, which is preferably closable by a preheating chamber door. The preheating chamber hollow space is connectable to the bending zone, in particular to the bending chamber hollow space of a bending zone implemented as a bending chamber, in order to deliver bent panes to the second tempering frame position. Preferably, but not mandatorily, the second press frame position is identical to the first tempering frame position. The tempering frame is coupled to a tempering frame movement mechanism by means of which the tempering frame can be moved reciprocally laterally between the first tempering frame position and the second tempering frame position to the first and second bending mould. The tempering frame movement mechanism is not coupled to the carrier for the press frame.

The device according to the invention for bending panes serves in particular for carrying out the method according to the invention described in the following. In this regard, in the context of the description of the methods according to the invention, reference is made to the statements above. The method comprises the following (e.g., successive) steps:

A step, in which a pane heated to bending temperature is provided in a removal position associated with the first bending mould.

Another step, in which the pane is secured against a contact surface of the first bending mould. Advantageously, a securing of the pane against the contact surface of the first bending mould is done in that the pane is raised by blowing on it with a gaseous fluid and pressing it against the contact surface of the first bending mould. Alternatively, and preferably additionally, the pane is secured against the contact surface of the first bending mould by suction. For example, but not mandatorily, the pane is subjected on the contact surface of the first bending mould to edge pre-bending in the edge region and/or surface pre-bending in the inner region of the pane.

A step, in which a press frame for the pane is positioned in a first press frame position associated with the first bending mould, in particular while the pane is secured against the first bending mould.

A step, in which the pane is placed on the press frame. When the press frame is implemented as a press frame, the method can include another step, in which the pane is pressed between the first bending mould and the press frame, wherein edge pre-bending or edge final bending is done in the edge region of the pane.

A step, in which the pane is transported on the press frame to a second press frame position associated with the second bending mould. During transport of the pane on the press frame, surface pre-bending is preferably done by gravity in an inner region of the pane surrounded by the edge region. This is advantageous in particular when the pane was pressed between the first bending mould and the press frame implemented as a press frame. When the press frame is implemented as a press frame, the method can include another step, in which the pane is pressed between the second bending mould and the press frame, wherein edge pre-bending or edge final bending in the edge region of the pane is done.

A step, in which the pane is secured against a contact surface of the second bending mould. In this case, for example, surface pre-bending or surface final bending can occur in the inner region and edge pre-bending or edge final bending can occur in the edge region of the pane. Advantageously, the pane is secured against the contact surface of the second bending mould by suction.

Here, it is essential for the press frame to be attached on a carrier introduced by a delivery module (preferably a delivery chamber) into the bending zone (preferably a bending chamber), wherein the press frame is moved laterally relative to the first and second bending mould by moving the carrier between the first press frame position and the second press frame position. Preferably, the delivery module is movable and is delivered to the bending zone.

In an advantageous embodiment of the invention, the press frame and/or the carrier are supported downward in the first press frame position and/or in the second press frame position.

In another advantageous embodiment of the method according to the invention, at least one tool connectable to the first bending mould and/or to the second bending mould is transported on the carrier between the delivery module and the bending zone. Particularly advantageously, the at least one tool is heated in the delivery module prior to transport into the bending zone.

In another advantageous embodiment of the method according to the invention, the method includes another step, in which the pane is transported on a (cool) tempering frame to a cooling device for the thermal tempering of the pane. During transport on the tempering frame, surface final bending in the inner region of the pane can be done by gravity.

Advantageously, while the pane is secured against the second bending mould, the tempering frame for tempering the pane is positioned in a first tempering frame position associated with the second bending mould, the pane is placed on the tempering frame, and the tempering frame is moved laterally relative to the second bending mould between the first tempering frame position and a second tempering frame position for tempering the pane. Preferably, the tempering frame is moved reciprocally (bidirectionally) translationally (one-dimensionally) in a horizontal plane between the first tempering frame position and the second tempering frame position.

In an advantageous embodiment of the method according to the invention, edge pre-bending is done in the edge region of the pane by pressing the pane between the first bending mould and the press frame. Then, further edge pre-bending is done in the edge region of the pane by pressing the pane between the second bending mould and the press frame. Finally, edge final bending of the pane is done during transport of the pane on the tempering frame.

In another advantageous embodiment of the method according to the invention, edge pre-bending is done in the edge region of the pane by pressing the pane between the first bending mould and the press frame. Then, edge final bending is done in the edge region of the pane by pressing the pane between the second bending mould and the press frame.

In another advantageous embodiment of the method according to the invention, edge final bending is done in the edge region of the pane by pressing the pane between the first bending mould and the press frame.

The bending on the second bending mould can give the pane a final or quasi-final shape. Typically, but not mandatorily, the shape of the pane will still change (usually slightly) on the tempering frame, for which purpose the tempering frame preferably has a frame surface that is suitably designed for edge final bending. In addition, the tempering frame is suitably designed for surface final bending by gravitation. The pane thus receives its final shape on the tempering frame.

The invention further extends to the use of the device according to the invention as well as the method according to the invention for producing panes for means of transportation on land, in the air, or on water, in particular in motor vehicles, and in particular for rear windows in motor vehicles.

The various embodiments of the invention can be realised individually or in any combinations. In particular, the features mentioned above and to be explained in the following can be used not only in the combinations indicated, but also in other combinations or in isolation, without departing from the scope of the present invention.

The invention is explained in detail using exemplary embodiments and referring to the accompanying figures. They depict, in simplified, not-to-scale representation;

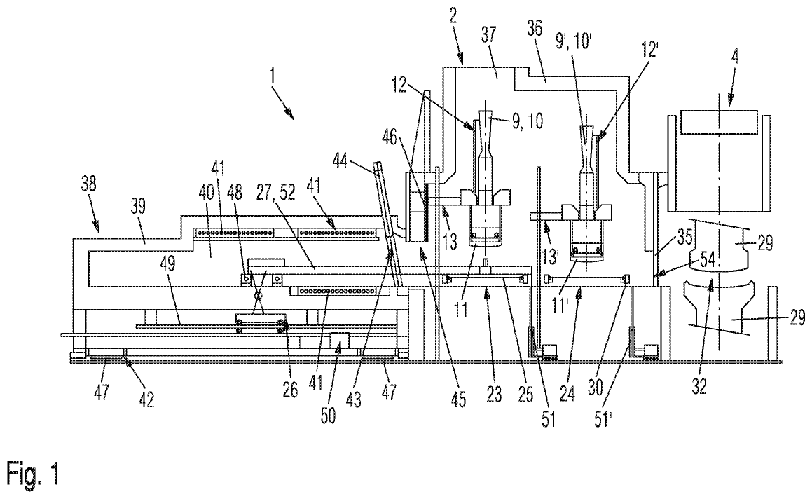

FIG. 1 a schematic representation of an exemplary embodiment of the device according to the invention for bending panes, in cross-section;

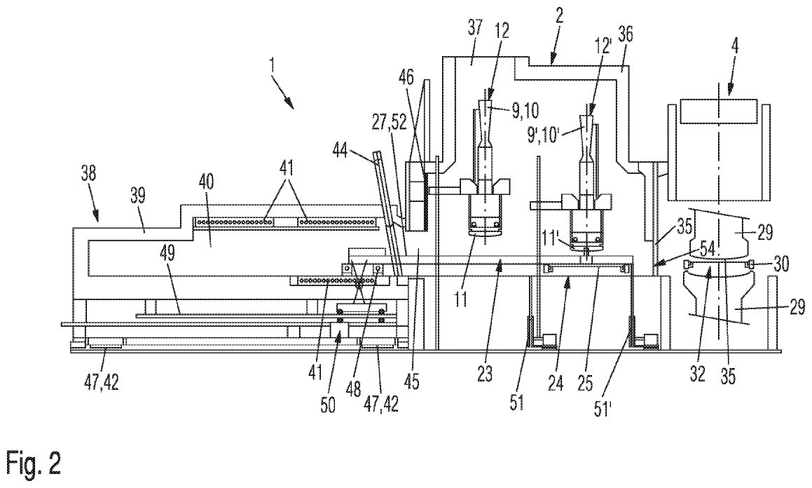

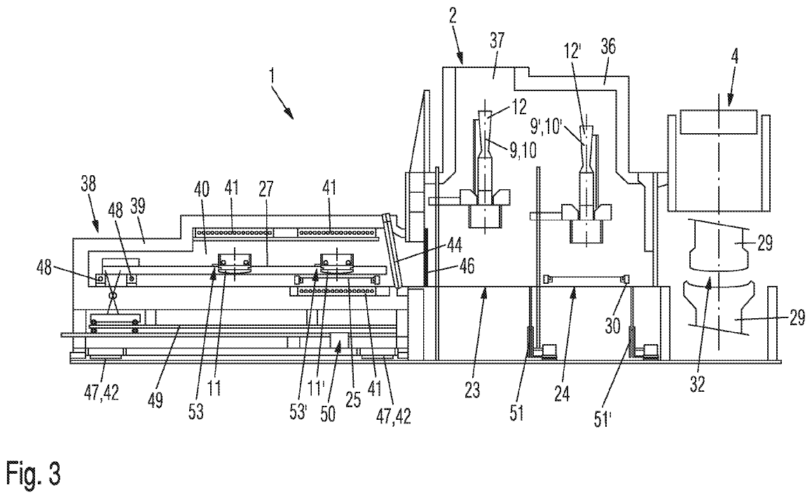

FIG. 2-3 further schematic representations of the device of FIG. 1 in different phases of the method according to the invention;

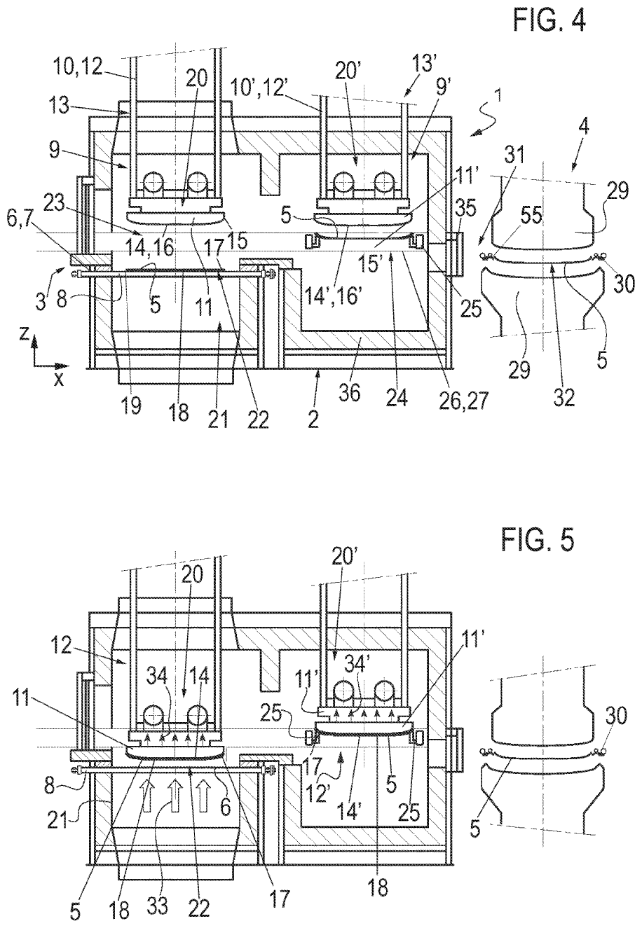

FIG. 4-10 the device according to the invention for bending panes of FIG. 1 without a delivery module at different times;

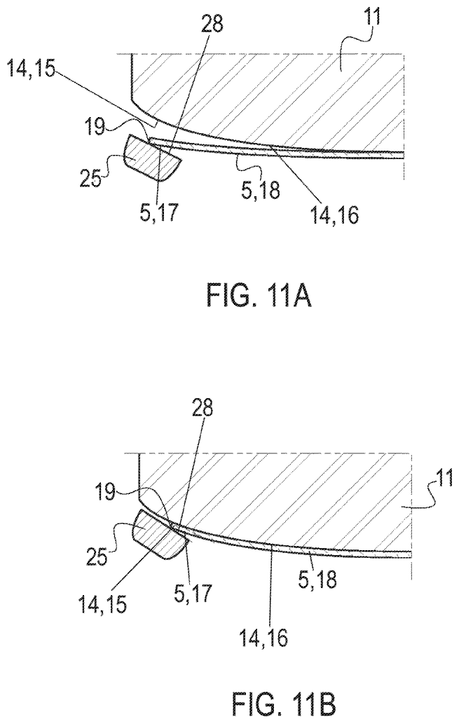

FIG. 11A-11B schematic representations for illustrating the pressing of a pane between the first bending tool and the press frame;

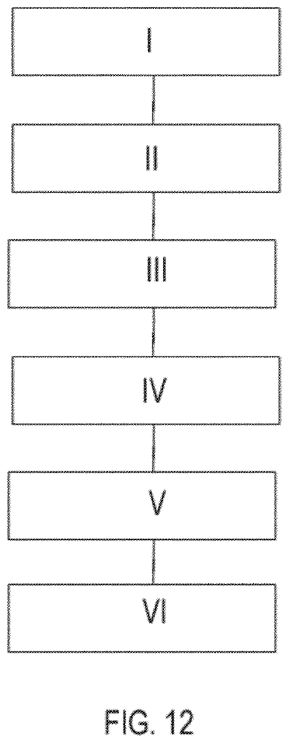

FIG. 12 a flowchart of the method according to the invention for producing a pane.

Consider first FIGS. 1 and 4, which illustrate, using schematic representations, an exemplary embodiment of the device according to the invention in a cross-sectional view. Referring to FIG. 1, essential components of the device for bending panes referenced as a whole with the reference number 1 are described. FIG. 4 represents an enlarged detail of the device 1 for bending panes of FIG. 1 without the delivery module 38.

The device 1 comprises a bending zone, which is implemented here, for example, as a closed or closable bending chamber 2 for bending (glass) panes 5, a preheating zone 3 arranged to the side of the of the bending chamber 2, with a heating device for heating the panes 5 to bending temperature, which is not shown in detail since in the views depicted, it is situated behind the bending chamber 2, and a tempering zone 4 for cooling or tempering bent panes 5, arranged to the side of the bending chamber 2. The tempering zone 4 is coupled on the right side to the bending chamber 2. The preheating zone 3 and the tempering zone 4 are, viewed from above, arranged at an angle of 90° to the bending chamber 2 and are functionally coupled thereto. The preheating zone 3, bending chamber 2, and tempering zone 4 are implemented here in each case as spatially separate regions of the device. The bending chamber 2 is provided with an insulating bending chamber wall 36, which separates a hollow space of the bending chamber 2, referred to in the following as bending chamber hollow space 37, from the external environment. As a result, the bending chamber hollow space 38 can be heated to and kept at a temperature (bending temperature) suitable for the bending operation of the panes 5. For heating the bending chamber hollow space 37, the bending chamber 2 has a heating device, which is not shown in detail in FIG. 1.

In the device 1, the panes 5 can be transported successively from the preheating zone 3 into the bending chamber 2 and, finally, into the tempering zone 4. Provided for transport of the panes 5 from the preheating zone 3 into the bending chamber 2 is a pane transport mechanism 6, comprising, here, for example, a roller bed 7 with cylindrical rollers 8 for flat support of panes 5. The rollers 8 are actively and/or passively rotatably mounted, with their horizontally oriented axes of rotation, here, for example, parallel to the x-direction. By means of the rollers 8, panes 5 heated to bending temperature in the preheating zone 3 can be brought in each case individually and successively into a removal position 22 in the bending chamber hollow space 37 of the bending chamber 2. The transport direction for the pane 5 is perpendicular to the plane of the drawing.

The bending chamber 2 has, in the bending chamber hollow space 37, two spatially separated bending stations 9, 9′, with a first bending station 9 and a second bending station 9′ arranged offset from one another in the horizontal x-direction. In the description of the two bending stations 9, 9′, the reference characters with “′” refer in each case to a component of the second bending station 9′, with components of the second bending station also possibly not having “′”, when this seems appropriate. For easier reference, all components of the second bending station 9′ are also referred to as “second” components, in contrast to the components of the first bending station 9, which are also referred to as “first” components.

The bending stations 9, 9′ have in each case a vertical holder 10, 10′ for releasable attachment of a bending tool 11, 11′. The holders 10, 10′ are in each case vertically displaceable by a holder moving mechanism 13, 13′ (not depicted in detail). Optionally, the holders 10, 10′ are laterally displaceable by the holder moving mechanism 13, 13′ in each case also with at least one horizontal movement component, in particular in the positive or negative x-direction. The bending tool 11, 11′ is in each case detachably mounted at the lower end of the holders 10, 10′. Each bending tool 11, 11′ has a downward-directed, convex contact surface 14, 14′ for the flat contact of a pane 5. With appropriate contact pressure, the pane 5 can be bent on the respective contact surface 14, 14′. The two contact surfaces 14, 14′ have, for this purpose, in each case an end or edge outer surface section 15, 15′ and an inner surface section 16, 16′ with mutually different surface contours (surface shapes), wherein the inner surface section 16, 16′ is completely surrounded (bordered) by the outer surface section 15, 15′.

In addition to the mutually different surface contours of an outer surface section 15, 15′ and an inner surface section 16, 16′ of one and the same bending tools 11, 11′, the contact surfaces 14, 14′ of the two bending tools 11, 11′ also have different surface contours. Specifically, the outer surface section 15 of the contact surface 14 of the first bending tool 11 has a surface contour that is adapted to a desired edge final bending, i.e., final bending, in a (for example, strip-shaped) edge region 17 of the pane 5, or, in further processing, enables such final bending. The end edge region 17 of the pane 5 is adjacent a pane (cut) edge 19 arranged perpendicular to the two opposing pane primary surfaces. The inner surface section 16 of the contact surface 14 of the first bending tool 11 has a surface contour that corresponds to a surface pre-bending, i.e., non-final bending, in an inner region 18 of the pane 5 completely surrounded by the edge region 17. The outer surface section 15′ of the contact surface 14′ of the second bending tool 11′ has a same surface contour as the outer surface section 15 of the contact surface 14 of the first bending tool 11 and has a surface contour that is adapted to the desired edge final bending in the edge region 17 of the pane 5. In contrast to the inner surface section 16 of the contact surface 14 of the first bending tool 11, the inner surface section 16′ of the contact surface 14′ of the second bending tool 11′ has a surface contour that is adapted to a surface final bending, i.e., a final or quasi-final bending, in the inner region 18 of the pane 5, or enables this in further processing. The first holder 10 forms, together with the first bending tool 11, a first bending mould 12. In a corresponding manner, the second holder 10′ forms, together with the second bending tool 11′, a second bending mould 12′.

The two bending stations 9, 9′ are in each case provided with a suction device 20, 20′ for sucking a pane 5 against the contact surface 14, 14′. For this purpose, the contact surfaces 14, 14′ can, for example, be provided with evenly distributed suction holes (not shown) and/or an apron positioned at the edge. By means of a negative pressure or a vacuum that is produced, a pane 5 can be pulled against the contact surface 14, 14′.

The first bending station 9 further has a blowing device 21 (not shown in detail) by means of which a flowing gaseous fluid, for example, an air flow 33, can be produced in a vertical direction through the roller bed 7. As a result, a pane 5 situated in the removal position 22 can be raised in the direction of the first bending mould 12. The removal position 22 is situated in a vertical direction directly below the bending tool 11 of the first bending mould 12.

The device 1 further includes a movable (mobile) delivery chamber 38, which is arranged opposite the tempering zone 4 on the outside of the bending chamber 2. Like the bending chamber 2, the delivery chamber 38 is implemented in the form of a closed or closable chamber. The delivery chamber 38 includes, for this purpose, an insulating delivery chamber wall 39, which delimits a hollow space of the delivery chamber 38, referred to in the following as “delivery chamber hollow space 40”, relative to the external environment. The delivery chamber hollow space 40 is accessible from the outside through at least one delivery chamber opening 43 into the delivery chamber hollow space 40. The delivery chamber opening 43 is closable by means of a delivery chamber door 44 such that the delivery chamber hollow space 40 can be opened and closed relative to the external environment. As shown in FIG. 1, the delivery chamber 38 is arranged outside the bending chamber 2, with the delivery chamber opening 43 in a position opposite a first bending chamber opening 45 of the bending chamber hollow space 37. The bending chamber hollow space 37 is accessible from the outside through the first bending chamber opening 45 into the bending chamber hollow space 37. The first bending chamber opening 45 is closable by means of a first bending chamber door 46.

When the delivery chamber 38 is arranged at the bending chamber 2, the bending chamber hollow space 37 and the delivery chamber hollow space 40 can be spatially connected to one another by opening both the delivery chamber door 44 and the first bending chamber door 46. On the other hand, the delivery chamber hollow space 40 can be spatially separated from the bending chamber hollow space 37 by closing the delivery chamber door 44 and/or the first bending chamber door 46.

The delivery chamber 38 is movable relative to the bending chamber 2 and has, for this purpose, an actively or passively drivable delivery chamber movement mechanism 42 for moving the delivery chamber 38, which is implemented in the present exemplary embodiment by air cushion platforms 47, which can be subjected to pressurised air for generating air cushions below the delivery chamber 38, on which the delivery chamber 38 can float. It would, however, also be conceivable to implement the delivery chamber movement mechanism 42, for example, in the form of a roller mounting. By means of the delivery chamber movement mechanism 42, the delivery chamber 38 can be delivered to the bending chamber 2 or moved away from the bending chamber 2.

The delivery chamber hollow space 40 is delimited by an insulating delivery chamber wall 39. Thus, the delivery chamber hollow space 40 can be heated to and kept at a desired temperature. For example, the delivery chamber hollow space 40 is, like the bending chamber 2, heated to and kept at a temperature suitable for the bending operation of the panes 5 (bending temperature). For heating the delivery chamber hollow space 40, the delivery chamber 38 has a delivery chamber heating device 41, implemented in the embodiment of FIG. 1 as radiant heaters. The radiant heaters are arranged distributed in multiple radiant heater arrays.

The delivery chamber 38 further has an elongated carrier 27 for a press frame 25. The carrier 27 is movable by means of a carrier movement mechanism 26. The carrier movement mechanism 26 includes a carriage 48, on which the carrier 27 is mounted, with the carriage 48 movable along an elongated carriage guide 49 that is completely accommodated in the delivery chamber hollow space 40. The carrier movement mechanism 26 further includes a drive device 50 that can move the carriage 48 together with the carrier 27 along the carriage guide 49 reciprocally and translationally. As shown in FIG. 1, the carriage guide 49 extends to the bending chamber 2, wherein a section of the carrier 27 can be introduced into the bending chamber hollow space 37 with an opened delivery chamber door 44 and an opened bending chamber door 46 by moving the carriage 48 along the carriage guide 49 in the direction toward the bending chamber 2. On the other hand, the carrier 27 can be removed from the bending chamber hollow space 37 by moving the carriage 48 in the opposite direction and can be completely accommodated in the delivery chamber hollow space 40. The drive device 50 for the carrier 27 is arranged outside the heatable delivery chamber hollow space 40 (in FIG. 1 below the delivery chamber hollow space 40). The drive device 50 can, in principle, be implemented in any desired manner so long as precise positioning of the carrier 27 is enabled. In the exemplary embodiment depicted, the drive device 50 is implemented in the form of a sprocket chain mechanism equipped with a driven pinion, which is known to the person skilled in the art and need not be explained in detail. In the situation shown in FIG. 1, the carrier 27 is introduced into the bending chamber 2 and is thus situated partially in the delivery chamber hollow space 40 and partially in the bending chamber hollow space 37. The delivery chamber door 44 and the bending chamber door 46 are, in each case, in an open position. Of course, the delivery chamber 38 and the bending chamber 2, including their components, are implemented such that a section of the carrier 27 carrying the press frame 25 can be introduced from the delivery chamber hollow space 40 into the bending chamber hollow space 37.

The press frame 25, which is used for transporting a pane 5, is fixedly mounted at the free end of the carrier 27, For this, the carrier 27 includes, for example, two parallel carrier arms 52, between which the press frame 25 is attached. When the carrier 27 has been (partially) introduced into the bending chamber hollow space 37, the press frame 25 can be moved laterally within the bending chamber hollow space 37 (reciprocally and translationally) relative to the first and second bending mould 12, 12′ by moving the carrier 27. In particular, the press frame 25 can be moved by moving the carrier 27 between a first press frame position 23 associated with the first bending mould 12 and a second press frame position 24 associated with the second bending mould 12′, Preferably, the first press frame position 23 is situated vertically (e.g., directly) below the first bending mould 12 and the second press frame position 24 is situated vertically (e.g., directly) below the second bending mould 12′. FIG. 1 depicts a situation in which the transport frame 25 is situated in the first press frame position 23. A tempering frame 30 is situated in the second press frame position 24. Here, the second press frame position 24 is identical to a first tempering frame position, wherein the tempering frame 30 is movable translationally and reciprocally within the tempering zone 4 by means of a tempering frame movement mechanism 31 between the first tempering frame position 24 and a second tempering frame position 32.

With the device 1 according to the invention, movement of the press frame 25 within the bending chamber 2 is done by the carrier 27 delivered from outside the bending chamber 2, with the drive device 50 for the carrier 27 arranged outside the heatable delivery chamber hollow space 40, enabling, in a particularly advantageous manner, very accurate positioning of the press frame 25.

As shown in FIG. 1, both in the first press frame position 23 and in the second press frame position 24, a support device 51, 51′ is arranged for supporting the carrier 27 downward. Here, the support device 51, 51′ is, for example, implemented in each case as a hydraulic or pneumatic support device. As a result, the press frame 25 can be positioned very accurately in the first press frame position 23 or in the second press frame position 24 without any position change, in particular due to physical contact with the first bending mould 12 or the second bending mould 12′, in order to further improve the accuracy of the pane processing. FIG. 1 depicts a situation in which the press frame 25 or the carrier 27 is supported in the first press frame position 23 by the support device 51.

Reference is now made to FIG. 2, wherein the device 1 for bending panes 5 is shown in a process situation different from FIG. 1. In order to avoid unnecessary repetitions, only the differences relative to FIG. 1 are explained, and, otherwise, reference is made to the statements above. In the situation of FIG. 2, the tempering frame 30 has been moved within the tempering zone 4 from the first tempering frame position 24 into the second tempering frame position 32. The press frame 25 has been moved from the first press frame position 23 by moving the carrier 27 into the second press frame position 24. In the second press frame position 24, the press frame 25 or the carrier 27 is supported downward by the second support device 51′.

Reference is now made to FIG. 3, wherein the device 1 for bending panes 5 is shown in a process situation different from FIG. 2. In order to avoid unnecessary repetitions, only the differences relative to FIG. 1 are explained, and, otherwise, reference is made to the above statements. In the situation of FIG. 3, the carrier 27 has been driven back by moving the carriage 48 on the carriage guide 49 completely into the delivery chamber hollow space 40. The two tools 11, 11′ of the first and second bending mould 12, 12′ are placed on the carrier 27. For example, the tool 11 of the first bending mould 12 is placed on a tool support 53 (not shown in detail) on the carrier 27. The other tool 11′ of the second bending mould 12′ is, for example, placed on the press frame 25, which serves as tool support 53′. For this purpose, the carrier 27 was moved such that the tool 11 could be placed on the first tool support 53 and the tool 11′ could be placed on the second tool support 53′. Here, the first tool support 53 was brought into a first tool position that is identical to the first press frame position 23. Correspondingly, the second tool support 53′ was brought into a second tool position that is identical to the second press frame position 24. The first tool support 53 and the second tool support 53′ are, for this purpose, arranged on the carrier 27 with a distance between them that corresponds to the distance between the first press frame position 23 and the second press frame position 24. For placing the two tools 11, 11′, the two bending moulds 12, 12′ were, in each case, moved vertically downward. Then, the carrier 27 with the tools 11, 11′ placed thereon was moved completely into the delivery chamber hollow space 40. The capability of transporting the two tools 11, 11′ by means of the carrier 27 enables a simple and fast tool change on the two bending moulds 12, 12′. Particularly advantageously, tools can be heated in the delivery chamber hollow space 40 prior to equipping the two bending moulds 12, 12′, as a result of which time-consuming heating in the bending chamber hollow space 37 can be avoided. In addition, simple maintenance of tools is enabled. The delivery chamber hollow space 40 can be closed to the external environment by closing the delivery chamber door 44, enabling fast heating of tools in the delivery chamber hollow space 40. Especially advantageously, the bending chamber hollow space 37 of the bending chamber 2 can be closed by closing the first bending chamber door 46. Since the bending chamber 2 is closed, a delivery module can be moved away from the bending chamber 2 in a simple manner without the bending chamber hollow space 37 being exposed to the external environment, making it possible, in particular, to avoid a greater temperature drop in the bending chamber hollow space. Accordingly, a different delivery module can be coupled in a simple manner to the bending chamber 2. With a closed delivery chamber hollow space 40, the tools accommodated in the delivery chamber hollow space 40 can be heated efficiently and quickly. Thus, a quick change of delivery modules is enabled at the bending chamber, in particular in order to quickly and economically bring different tools to the bending moulds 12, 12′ for use.

In the device 1, the press frame 25 is used for pressing and transporting a pane 5. The press frame 25 has, for this purpose, an edge-positioned (for example, strip-shaped) press surface 28 (see FIGS. 11A and 11B), whose surface contour is complementary to the surface contour of the outer surface sections 14, 14′ of the bending tools 11, 11′ of the first bending mould 12 and the second bending mould 12′. The upward facing press surface 28 is suitable for pressing a pane 5 resting thereon in the edge region 17. The press frame 25 is not implemented full surface, but, instead, has an inner opening, which also enables gravity pre-bending of the surface of the inner region 18 of a pane 5 placed thereon.

The tempering zone 4 laterally coupled to the bending chamber 2 has two so-called “tempering boxes” 29, which are arranged offset from one another in the vertical direction. By means of the two tempering boxes 29, a flow of air can be generated in each case for air cooling a pane 5 situated between the two tempering boxes 29 in order to temper the bent pane 5. The tempering frame 30 is used for transporting and storing during the tempering of a bent pane 5. The tempering frame 30 can be displaced laterally by a tempering frame movement mechanism 31 (not shown in detail here) along at least one horizontal movement component relative to the bending station 2. Specifically, the tempering frame 30 can be moved back and forth in a horizontal plane between the first tempering frame position 24 and the second tempering frame position 32, which is situated between the two tempering boxes 29 of the tempering zone 4. The bending chamber hollow space 37 is accessible from the outside through a second bending chamber opening 54 into the bending chamber hollow space 37. The second bending chamber opening 54 is closable by a second bending chamber door 35 such that the bending chamber hollow space 37 can be opened to the outside and can be closed against the external environment. The tempering frame 35 can be transported through the opened second bending chamber opening 54 into the bending chamber hollow space 37 in order to accommodate a fully bent pane 5 and to transport it into the tempering zone 4. From there, the pane 5 can be removed in a simple manner and further processed.

Reference is now made to FIGS. 4 to 10, wherein the device 1 for bending panes 5 of FIG. 1 is depicted in each case at different successive times during a bending process in order to describe an exemplary method for bending panes 5. For better clarity, only selected components of the device 1 are provided with reference numbers. In addition, the device 1 is depicted without the delivery module 38.

FIG. 4 depicts a situation during the bending process wherein a pane 5 has been brought into the removal position 22 of the first bending station 9. The first bending mould 12 is situated in a raised position above the pane 5. The second bending mould 12′ is situated at approx. the same height as the first bending mould 12. Below the second bending mould 12′, the press frame 25 is situated in the second press frame position 24 of the second bending station 9′ with a further pane 5 placed thereon. The tempering frame 30 is situated in the second tempering frame position 32 of the tempering zone 4 between the two tempering boxes 29.

FIG. 5 depicts the device 1 for bending panes 5 at a later time than FIG. 1. The first bending mould 12 is driven downward in the direction of the pane 5 from the raised position into a first lowered position. The pane 5 has been raised by blowing with the blowing device air flow 33 (symbolically represented by arrows) generated by the blowing device 21 on its lower side in the vertical direction from the removal position 22 in the direction toward the first bending mould 12 and is pressed by the blowing device air flow 33 against the contact surface 14 of the first bending tool 11. In the first lowered position of the first bending mould 12, the contact surface 14 is lowered far enough for the pane 5 to be able to be pressed by the blowing device air flow 33 against the contact surface 14. In addition, the pane 5 is secured against the contact surface 14 by suction by means of the suction device 20. The suction device air flow 34 producing a negative pressure on the contact surface 14 is also symbolically represented by arrows. As a result of the typically incomplete contact against the contact surface 14, a pre-bending of the pane 5 occurs only in the edge region 17. Generally, the pressing pressure from the blowing device air flow 33 is not sufficient to produce a edge final bending in the edge region 17 of the pane 5. On the other hand, the sucking action of the suction device 20 serves substantially only for holding the pane 5 against the contact surface 14, until the press frame 25 has traveled under the pane 5, and has only a slight influence on the bending of the pane 5. Nevertheless, bubbles in the pane 5 can be removed thereby. In the inner region 18 of the pane 5, only pre-bending of the surface is still possible as result of the contact surface 14. FIG. 2 depicts a situation in which the pane 5 is already secured against the contact surface 14.

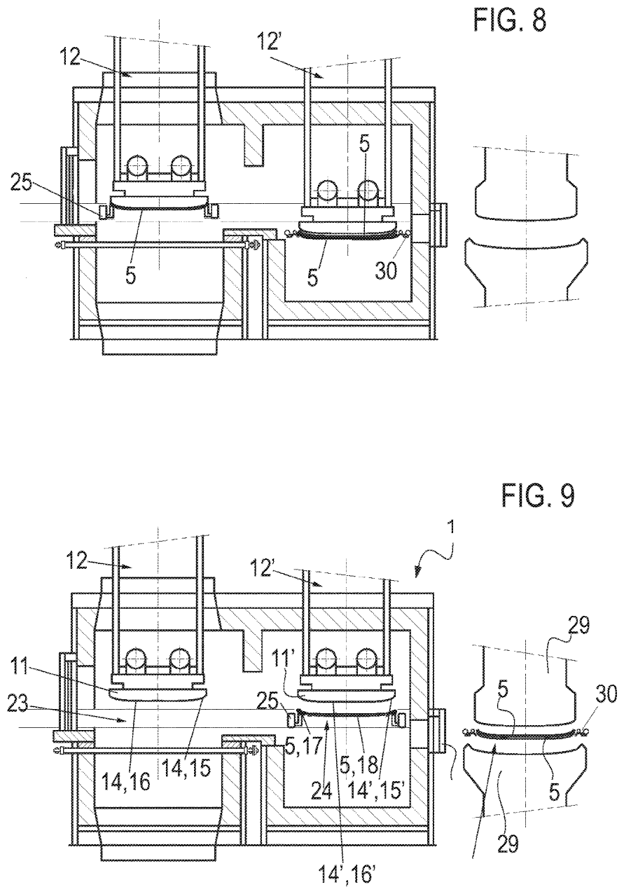

The second bending mould 12′ has been brought from the raised position into a lowered position in which there is surface contact between the contact surface 14′ and the pane 5 positioned on the press frame 25. Here, the pane 5 is pressed in the edge region 17 between the outer surface section 15′ of the contact surface 14′ of the bending tool 11′ and the press surface 28 of the press frame 25 (see FIGS. 8A and 8B). The press surface 28 has a shape complementary to the outer surface section 15′ of the contact surface 14. As a result, the edge region 17 of the pane 5 is preferably fully bent, in other words, receives its edge final bending. It is, however, also possible for the edge region 17 to only be pre-bent. Subsequently, the pane 5 is secured against the contact surface 14′ by suction by means of the suction device 20′. It is conceivable for the contact surface 14′ to, alternatively, have a small distance from the pane 5, if suction of the pane 5 over a certain distance is possible. The suction device air flow 34′ generating negative pressure on the contact surface 14′ is symbolically represented by arrows. In contrast to the first bending mould 12 where only holding of the pane 5 is intended and the negative pressure thus causes no bending (at least no notable bending) of the pane 5, the suction of the pane 5 against the contact surface 14′ can also serve for bending the pane 5, in other words, sufficient mechanical pressure to bend the pane 5 as desired is generated by the suction. Thus, the pane 5 is pre-bent on the second contact surface 14′ in the inner region 18 of the pane 5. In addition, a previously produced edge final bending in the edge region 17 can be maintained on the pane 5. The tempering frame 30 is still situated in the tempering device 4 between the two tempering boxes 29.

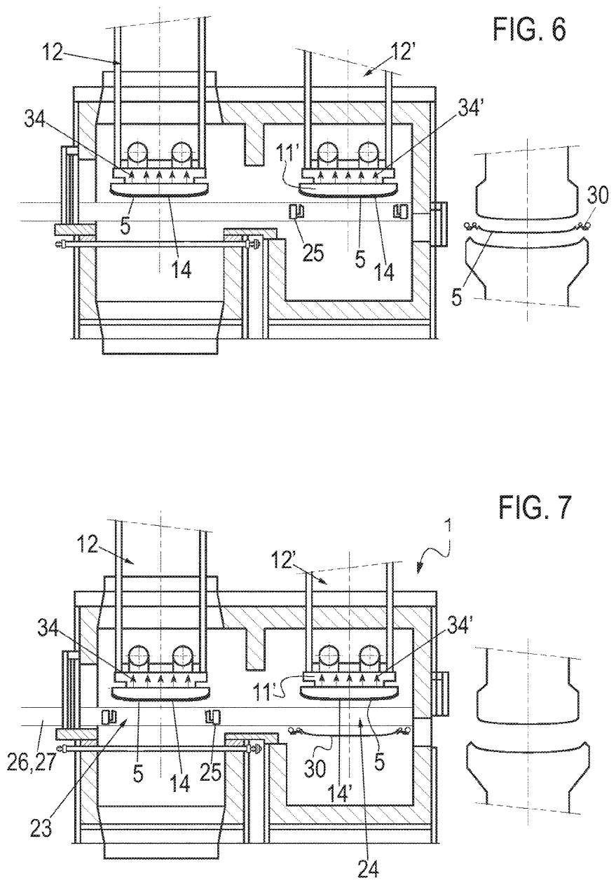

FIG. 6 depicts the device 1 for bending panes 5 at a later time than FIG. 5. The first bending mould 12 has again been moved upward into its raised position, wherein the pane 5 is secured against the contact surface 14 by the suction device air flow 34. The second bending mould 12′ has also been moved upward into its raised position, wherein the pane 5 is secured against the contact surface 14′ by the suction device air flow 34′. The press frame 25 is pane-free and is situated below the second bending mould 12′. The tempering frame 30 is still situated in the tempering device 4 between the two tempering boxes 29.

FIG. 7 depicts the device 1 for bending panes 5 at a later time than FIG. 6. The first bending mould 12 is depicted in a situation wherein it has moved downward on the way into a second lowered position above the first lowered position. The pane 5 is still secured against the contact surface 14 by the suction device air flow 34. The press frame 25 has been moved translationally by means of the carrier movement mechanism 26 on the carrier 27 in a horizontal direction (negative x-direction) from the second press frame position 24 to the first press frame position 23 and is situated below the first bending mould 12. The second bending mould 12′ is still situated in its raised position, wherein the pane is secured against the contact surface 14′ by the suction device air flow 34′. The tempering frame 30 has been moved from the tempering position 32 into the second press frame position 24 of the second bending station 9′ and is situated below the second bending mould 12′.

FIG. 8 depicts the device 1 for bending panes 5 at a later time than FIG. 7. The first bending mould 12 has now been moved into the second lowered position, wherein the pane 5 comes into contact with the press frame 25. Here, the pane 5 is pressed in the edge region 17 between the outer surface section 15 of the contact surface 14 of the bending tool 11 and the press surface 28 of the press frame 25 (see FIGS. 11A and 11B). The press surface 28 has a shape complementary to the outer surface section 15 of the contact surface 14. The edge region 17 of the pane 5 is, thereby, pre-bent or fully bent. A major advantage of the pressing of the pane 5 against the press frame 25 is a resultant very precise definition of the position of the pane 5 on the press frame 5 with precise contact of the edge region 17 of the pane 5 on the press surface 28 of the press frame 25. This enables precise positional fixation of the pane 5 on the press frame 25 by means of the stop (not shown in detail) resting against the pane 5. Thus, particularly high production accuracy and good optical quality of the bent pane can be achieved. The second bending mould 12′ has been moved into its lowered position, wherein the pane 5 is placed on the tempering frame 30.

FIG. 9 depicts the device 1 for bending panes 5 at a later time than FIG. 8. The first bending mould 12 and second bending mould 12′ have, in each case, been moved back into their raised position. The press frame 25 has been moved translationally in a horizontal direction (positive x-direction) from the first press frame position 23 to the second press frame position 24 and is situated below the second bending mould 12′. In particular, during transport, the pane 5 situated on the press frame 25 is pre-bent in the inner region 18 by gravity. As a result of the pressing in the edge region 17, the surface pre-bending by means of gravity is limited in the inner region 18. The tempering frame 30 with the pane 5 placed thereupon has been moved from the second press frame position 24 of the second bending station 9′ into the tempering position 32 and is situated between the two tempering boxes 29. To enable exit from the bending zone 2, the door 35 was opened for a short time. Thus, an appreciable temperature loss in the bending zone 2 can be prevented. During transport on the tempering frame 30, an edge final bending of the edges and a surface final bending of the pane 5 can be done by gravity. The tempering frame 30 has, for this purpose, an upwardly directed frame surface 55 for contact with the pane 5, which is suitably designed for an edge final bending. In addition, the tempering frame 30 is suitably designed for a surface final bending by gravitation.

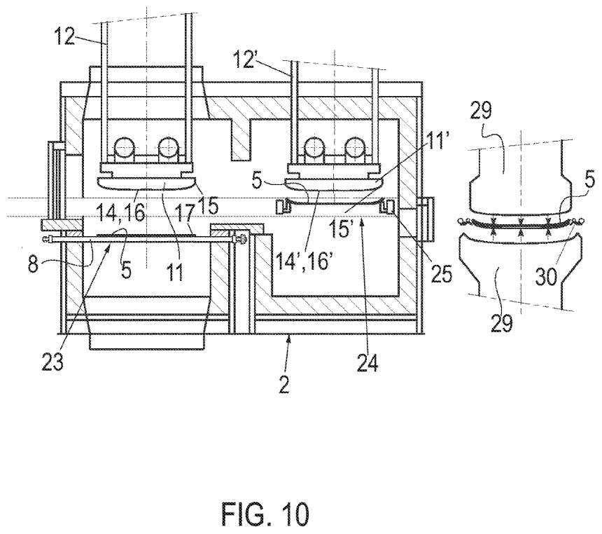

FIG. 10 depicts the device 1 for bending panes 5 at a later time than FIG. 9. The first bending mould 12 and second bending mould 12′ are still situated in the raised position. A new pane 5 has been brought into the removal position 22 of the first bending station 9. The pane 5 situated on the press frame 25 can be pressed and suctioned by the second bending mould 12′. The pane 5 situated in the tempering zone 32 is cooled by an air flow for tempering, as illustrated by arrows. The situation of FIG. 10 thus resembles the situation of FIG. 1. In this manner, the bending process can be carried out continuously.

FIGS. 11A and 11B depict the pressing of the pane 5 between the press frame 25 and the contact surface 14 of the first bending tool 11. Discernibly, the contact surface 14 has an outer surface section 15 and an inner surface section 16 with different surface contours. The outer surface section 15 has a surface contour that corresponds to the desired edge final bending in the edge region 17 of the pane 5 or enables such bending. The inner surface section 16 has a surface contour that corresponds to a surface pre-bending in the inner region 18 of the pane 5 or enables such pre-bending. The press surface 28 of the press frame 25 has a surface contour that is complementary to the surface contour of the outer surface section 15 of the contact surface 14. FIG. 11A depicts a situation in which the inner region 18 of the pane 5 comes to rest against the inner surface section 16 (first contact). This can already be construed as pressing. In FIG. 11B, the pane 5 has, even in the edge region 17, made complete contact against the outer surface section 15 of the contact surface 14, with the desired edge final bending in the edge region 17 having been produced.

FIG. 12 illustrates, referring to a flowchart, the successive steps of the method for producing the pane 5 using the device 1. Therein, in a first step I, a pane 5 heated to bending temperature is provided in the removal position 22. In a second step II, the pane 5 is secured against the contact surface 14 of the first bending mould 12. In a third step III, the press frame 25 for the pane 5 is positioned in the first press frame position 23. In a fourth step IV, the pane 5 is placed on the press frame 25. In a fifth step V, the pane 5 is transported on the press frame 25 to the second second press frame position 24. In a sixth VI, the pane 5 is secured against the contact surface 14′ of the second bending mould 12′.

In an exemplary embodiment of the method according to the invention, edge pre-bending in the edge region of the pane 5 is done by means of pressing the pane 5 between the first bending mould 12 and the press frame 25, and edge pre-bending in the edge region 17 of the pane 5 is done by means of pressing the pane 5 between the second bending mould 12′ and the press frame 25, wherein an edge final bending of the edges is done during transport on the tempering frame 30. During transport on the press frame 25, surface pre-bending is done in the inner region of the pane 5 by gravity. During transport on the tempering frame 30, surface final bending is done in the inner region of the pane 5 by gravity. The pane thus receives its final shape only on the tempering frame.

In another exemplary embodiment of the method according to the invention, edge pre-bending in the edge region 17 of the pane 5 is done by means of pressing the pane 5 between the first bending mould 12 and the press frame 25 and an edge final bending in the edge region 17 of the pane 5 is done by means of pressing the pane 5 between the second bending mould 12′ and the press frame 25. During transport on the tempering frame 30, a further edge final bending is done only in the sense that the already present edge final bending is not lost, i.e., the edge final bending is maintained. During transport on the press frame 25, surface pre-bending in the inner region of the pane 5 is done by gravity. During transport on the tempering frame 30, a surface final bending in the inner region of the pane 5 is done by gravity. The pane 5 thus receives its final shape in the edge region 17 already by means of the second bending mould 12′. The pane 5 receives its final shape in the inner region only on the tempering frame 30.

In another exemplary embodiment of the method according to the invention, an edge final bending in the edge region 17 of the pane 5 is done by pressing the pane 5 between the first bending mould 12 and the press frame 25. During transport on the press frame 25 and tempering frame 30, a further edge final bending is done only in the sense that the already present edge final bending is not lost, i.e., the edge final bending is maintained. During transport on the press frame 25, surface pre-bending in the inner region of the pane 5 is done by gravity. During transport on the tempering frame 30, a surface final bending in the inner region of the pane 5 is done by gravity. The pane 5 thus receives its final shape in the edge region 17 already by means of the first bending mould 12. The pane 5 receives its final shape in the inner region only on the tempering frame 30.

In all embodiments of the method, edge pre-bending and/or surface pre-bending can be done by securing the pane 5 against the first bending mould 12 or the second bending mould 12′. In addition, surface final bending can be done by securing the pane 5 against the second bending mould 12′.

From the above, it is clear that the invention provides a method as well as a compact device for producing panes by means of which a simple and economical production of panes with short cycle times is enabled. In particular, it can increase the throughput with complex glass designs. Particularly advantageously, the transport time on the press frame between the two bending moulds can be used for gravity bending in the inner region of the surface. By means of the delivery chamber with a carrier and a press frame mounted thereon, the press frame can be positioned with particularly high accuracy. The accuracy of the positioning of the pane on the press frame can be even further improved by the pressing of the pane between the first bending mould and the press frame in the edge region of the pane, wherein the pane is pre-bent or final bent in the edge region. Thus, panes with particularly high quality requirements are producible. In addition, by means of the delivery chamber and tools transported on the carrier, the tools of the two bending moulds can be easily and economically changed and/or serviced. Particularly advantageously, the tools can be heated before equipping the bending moulds such that the processing of panes can be quickly continued after a tool change. The invention thus enables a particularly economical production of panes with relatively short cycle times and particularly high quality requirements.

### LIST OF REFERENCE CHARACTERS

1 device
2 bending chamber
3 preheating zone
4 tempering zone
5 pane
6 pane transport mechanism
7 roller bed
8 roller
9,9′ bending station
10,10′ holder
11,11′ bending tool
12,12′ bending mould
13,13′ holder movement mechanism
14,14′ contact surface
15,15′ outer surface section
16,16′ inner surface section
17 edge region
18 inner region
19 pane edge
20,20′ suction device
21 blowing device
22 removal position
23 first press frame position/tool position
24 second press frame position f tool position, first tempering frame position
25 press frame
26 carrier movement mechanism
27 carrier
28 press surface
29 tempering box
30 tempering frame
31 tempering frame movement mechanism
32 second tempering frame position
33 blowing device air flow
34,34′ suction device air flow
35 second bending chamber door
36 bending chamber wall
37 bending chamber hollow space
38 delivery chamber
39 delivery chamber wall
40 delivery chamber hollow space
41 delivery chamber heating device
42 delivery chamber movement mechanism
43 delivery chamber opening
44 delivery chamber door
45 first bending chamber opening
46 first bending chamber door
47 air cushion platform
48 carriage
49 carriage guide
50 drive device
51,51′ support device
52 carrier arm
53,53′ tool support
54 second bending chamber opening
55 frame surface

1. A method for bending panes in a bending zone having a first bending mould and a second bending mould, comprising:
providing a pane heated to bending temperature,
securing the pane against a contact surface of the first bending mould,
positioning a press frame for the pane in a first press frame position associated with the first bending mould,
transporting the pane on the press frame to a second press frame position associated with the second bending mould,
securing the pane against a contact surface of the second bending mould,
wherein the press frame is attached to a carrier introduced into the bending zone by a delivery module, and wherein the press frame is moved laterally relative to the first and second bending mould by moving the carrier between the first press frame position and the second press frame position.

2. The method according to claim 1, wherein the delivery module is movable and is delivered to the bending zone.

3. The method according to claim 1, wherein at least one tool connectable to the first bending mould and/or to the second bending mould is transported on the carrier between the delivery module and the bending zone.

4. The method according to claim 3, wherein the at least one tool is heated in the delivery module.

5. The method according to claim 1, wherein the carrier is downwardly supported in the first press frame position and/or the second press frame position.

6. The method according to claim 1, wherein the pane is secured against the contact surface of the first bending mould and against the contact surface of the second bending mould by
blowing on the pane with a gaseous fluid, as a result of which the pane is raised and is pressed against the contact surface of the bending mould, and/or
sucking the pane against the contact surface.

7. The method according to claim 1, wherein, while the pane is secured against the contact surface of the second bending mould, a tempering frame for supporting the pane is transported to a first tempering frame position associated with the second bending mould, the pane is placed on the tempering frame, and the tempering frame carrying the pane is moved laterally relative to the second bending mould to a second tempering frame position for tempering the pane.

8. A device for bending panes, for carrying out the method according to claim 1, which comprises:
a bending zone with a first bending mould and a second bending mould,
a delivery module that is delivered to the bending zone such that a carrier with a press frame for a pane can be introduced into the bending zone, wherein the press frame is movable laterally relative to the first and second bending mould by moving the carrier between a first press frame position associated with the first bending mould and a second press frame position associated with the second bending mould.

9. The device according to claim 8, wherein the delivery module is movable relative to the bending zone.

10. The device according to claim 8, wherein the bending zone is implemented as a bending chamber with a bending chamber hollow space, wherein the first bending mould and the second bending mould are arranged in the bending chamber hollow space, and wherein the delivery module is implemented as a delivery chamber with a delivery chamber hollow space, wherein the carrier with press frame can be arranged completely in the delivery chamber hollow space.

11. The device according to claim 10, wherein the delivery chamber hollow space is heatable.

12. The device according to claim 11, wherein a carrier movement mechanism for moving the carrier s arranged at least partially outside the heatable delivery chamber hollow space.

13. The device according to claim 8, wherein at least one too connectable to the first and/or second bending mould is transportable on the carrier, wherein the tool is laterally movable relative to the first and second bending mould by moving the carrier between the bending zone and a first tool position associated with the first bending mould and/or a second tool position associated with the second bending mould.

14. The device according to claim 8, wherein at least one support device for supporting the press frame and/or the carrier is arranged in the first press frame position and/or in the second press frame position.

15. The device according to claim 8, further comprising a preheating zone with a heating device for heating panes to a bending temperature, as well as a transport mechanism for transporting panes from the preheating zone to the bending zone, and/or a tempering zone with a cooling device for the thermal tempering of a pane, wherein a tempering frame is movable laterally relative to the second bending mould for transporting a pane from a first tempering frame position associated with the second bending mould to a second tempering frame position in the tempering zone.

16. The device according to claim 15, wherein the transport mechanism is a roller bed.
